(19) United States
(12) Patent Application Publication
(10) Pub. No.: US 2004/0196556 A1
(43) Pub. Date: Oct. 7, 2004

(54) Diffraction grating for wavelength division multiplexing/demultiplexing devices

(76) Inventor: Gregory G. Cappiello, Windham, NH (US)

Correspondence Address: Thomas E. Anderson, Hunton & Williams LLP, 1900 K Street, N.W., Washington, DC, 20006-1109, US

(21) Appl. No.: 10/771,413

(22) Filed: Feb. 5, 2004

Related U.S. Application Data
(63) Continuation-in-part of application No. 09/724,803, filed on Nov. 28, 2000.
(60) Provisional application No. 60/208,478, filed on Jun. 2, 2000.

(51) Int. Cl. G02B 5/18

(52) U.S. Cl. 359/569

(57) ABSTRACT

A diffraction grating and devices employing same are disclosed. In one particular exemplary embodiment, the present invention may be realized as a diffraction grating comprising a reflective material having a blazed surface with a blaze angle between about 33 degrees and about 41 degrees, and an optically transmissive material disposed adjacent the reflective material having an index of refraction (n), wherein the blazed surface of the reflective material has approximately (350±30)*n number of grooves per millimeter.

### CROSS-REFERENCE TO RELATED APPLICATIONS

This patent application is a continuation-in-part (CIP) application of U.S. patent application Ser. No. 09/724,803, filed Nov. 28, 2000 (Client Reference No. D-99019-US; Attorney Docket No. 62687.000096) which claims priority to U.S. Provisional Patent Application No. 60/208,478, filed Jun. 2, 2000 (Client Reference No. D-99019-P; Attorney Docket No. 62687.000095), all of which are hereby incorporated by reference herein in their entirety.

### FIELD OF THE INVENTION

The present invention relates generally to wavelength division multiplexing and, more particularly, to a diffraction grating for relatively high efficiency wavelength division multiplexing/demultiplexing devices.

### BACKGROUND OF THE INVENTION

Optical communication technology relies on wavelength division multiplexing (WDM) to provide increased bandwidth over existing installed fiber optic lines, as well as newly deployed fiber optic line installations. Several technologies exist to provide the technical solution to WDM: array waveguide gratings (AWG's), fiber Bragg grating based systems, interference filter based systems, Mach-Zehnder interferometric based systems, and diffraction grating based systems, to name a few. Each system has advantages and disadvantages over the others.

Diffraction grating based systems have the advantage of parallelism, which yields higher performance and lower cost for high channel count systems. In particular, a diffraction grating is a device that diffracts light by an amount varying according to its wavelength. For example, if sunlight falls on a diffraction grating at the correct angle, the sunlight is broken up into its individual component colors (i.e., rainbow).

Gratings work in both transmission (where light passes through a material with a grating written on its surface) and in reflection (where light is reflected from a material with a grating written on its surface). In optical communications, reflective gratings have a widespread use. A reflective diffraction grating includes a very closely spaced set of parallel lines or grooves made in a mirror surface of a solid material. A grating can be formed in most materials wherein the optical properties thereof are varied in a regular way, having a period that is relatively close to the wavelength. Incident light rays are reflected from different lines or grooves in the grating. Interference effects prevent reflections that are not in-phase with each other from propagating.

There are two primary groove profiles in conventional diffraction gratings, blazed gratings and sinusoidal gratings. The blazed grating includes a jagged or sawtooth shaped profile. The sinusoidal grating has a sinusoidal profile along the surface of the grating.

The diffraction equation for a grating is generally described by:

Gmλ=n(sin(α)±sin(β))

where G=1/d is the groove frequency in grooves per millimeter, d is the distance between adjacent grooves, m is the diffraction order, λ is the wavelength of light in millimeters, α is the incident angle with respect to the grating normal, β is the exiting angle with respect to the grating normal, and n is the refractive index of the medium above the grooves.

FIG. 15A is a representative pictorial showing optical characteristics of a blazed diffraction grating in reflecting a narrowband optical signal. The blaze diffraction grating 900 is defined by certain physical parameters that effect optical performance. These physical parameters include the reflection surface material, the number of grooves g per millimeter, blaze angle θ_{B}, and the index of refraction of an immersed grating medium 902. The reflection surface 905 typically resides on a substrate 910.

As shown on FIG. 15A, the groove spacing is defined by d. An incident narrowband optical signal with a center wavelength λ₁ has an incident angle α₁ (measured from the grating normal N_{g}) and a reflection angle β₁ (also measured from the grating normal N_{g}). The angle between the grating normal N_{g} and the facet normal N_{f} defines the blaze angle θ_{B}.

As previously discussed, when narrowband light is incident on a grating surface, it is diffracted in discrete directions. The light diffracted from each groove of the grating combines to form a diffracted wavefront. There exists a unique set of discrete or distinct angles based upon a given spacing between grooves that the diffracted light from each facet is in phase with the diffracted light from any other facet. At these discrete angles, the in-phase diffracted light combine constructively to form the reflected narrowband light signal.

A sinusoidal diffraction grating is similarly described by the equation above. When α=β, the reflected light is diffracted directly back toward the direction from which the incident light was received. This is known as the Littrow condition. At the Littrow condition, the diffraction grating equation becomes:

m*λ=2*d*n*sin(α)

where n is the index of refraction of the immersed grating medium 902 in which the diffraction grating is immersed.

FIG. 15B is a representative pictorial showing optical characteristics of a sinusoidal diffraction grating. Sinusoidal gratings, however, do not have a blaze angle parameter, but rather have groove depth (d). An immersed grating medium 955 resides on the sinusoidal grating 950 having a certain index of refraction, n. The diffraction grating equation discussed above describes the optical characteristics of the sinusoidal diffraction grating based upon the physical characteristics thereof.

FIG. 15c shows a polychromatic light ray being diffracted from a blazed grating 960. An incident ray (at an incident angle θᵢ to the normal) is projected onto the blazed grating 960. A number of reflected and refracted rays are produced corresponding to different diffraction orders (values of m=0, 1, 2, 3 . . . ). The reflected rays corresponding to the diffraction order having the highest efficiency (i.e., lowest loss) are utilized in optical systems.

As with most communications systems, there is a need to provide improved optical transmission rate and more efficient propagation of the communication signals in the fiber optic communication system. By improving the efficiency and/or decreasing the loss of the communication signals, the need to install optical repeaters and/or optical amplifiers is reduced, thereby decreasing operating costs of the system. Furthermore, an increase in signal efficiency reduces demand on fiber optic lines in a system, thereby reducing the need for burying additional optic lines. The burying of additional fiber optic cable is quite costly as it is presently on the order of $15,000 to $40,000 per kilometer.

Because WDM devices generate optical signals, one area of improvement is focused on the insensitivity to signal polarization. As is well known, the polarization of a signal affects the speed at which pulse energy in the signal's polarization modes or states propagate in an optical fiber. As a result, polarized signals generally cause significant timing and signal reconstruction problems within an optical system.

Ultimately, signal performance within a WDM device is attributable to a great extent to the performance of the diffraction grating therein. Because the parameter values which describe the diffraction grating often dictate the efficiency and the polarization effects of diffracted optical signals, much time, money, and effort have been dedicated to determining diffraction grating parameter values to effectuate improved transmission performance. Due in part to the number of diffraction grating parameters, the considerable range of corresponding parameter values, and the interdependencies between the diffraction grating parameters, designing and implementing a diffraction grating yielding improved performance are nontrivial.

In this regard, designing diffraction gratings must additionally take into account real-world effects that can only be measured empirically to determine if the theoretical parameters for a diffraction grating yield a viable solution. For example, one difficulty in creating improved diffraction gratings is the prolonged time period for creating a master diffraction grating. A single diffraction grating master may take several weeks to produce. Although the master diffraction grating, having a specific set of grating parameters, may yield acceptable results (i.e., low loss or a partially polarization insensitive result), a replicated diffraction grating created from the master diffraction grating may produce less than desirable signal performance characteristics. Consequently, the process of designing and developing diffraction gratings (determining grating parameters that yield good signal and/or master grating related characteristics, producing a master diffraction grating having the determined grating parameters and producing a replicated diffraction grating from the master diffraction grating that yields good signal performance characteristics) so as to produce a diffraction grating having improved performance requires solving both theoretical and practical problems.

Based upon the foregoing, there is a need for a diffraction grating for employment within an optical system having improved signal performance.

### SUMMARY OF THE INVENTION

According to the present invention, a diffraction grating and devices employing same are provided. In one particular exemplary embodiment, the present invention may be realized as a diffraction grating comprising a reflective material having a blazed surface with a blaze angle between about 33 degrees and about 41 degrees, and an optically transmissive material disposed adjacent the reflective material having an index of refraction (n), wherein the blazed surface of the reflective material has approximately (350±30)*n number of grooves per millimeter.

In accordance with other aspects of this particular exemplary embodiment of the present invention, the number of grooves per millimeter for the reflective material may beneficially be between about 520 and about 560, and the index of refraction of the optically transmissive material may beneficially be between about 1.44 and about 1.64.

In accordance with further aspects of this particular exemplary embodiment of the present invention, the diffraction order associated with the lowest loss may beneficially be the second order.

In accordance with additional aspects of this particular exemplary embodiment of the present invention, the reflective material may beneficially be gold material, aluminum material, or silver material.

In accordance with still other aspects of this particular exemplary embodiment of the present invention, the diffraction grating may further beneficially comprise a substantially planar substrate on which the reflective material is formed.

In another particular exemplary embodiment, the present invention may be realized as a diffraction grating comprising a reflective material having a blazed surface with a blaze angle between about 32 degrees and about 40 degrees, and an optically transmissive material disposed adjacent the reflective material having an index of refraction (n), wherein the blazed surface of the reflective material has approximately (175±30)*n number of grooves per millimeter.

In accordance with other aspects of this particular exemplary embodiment of the present invention, the number of grooves per millimeter for the reflective material may beneficially be between about 240 and about 300, and the index of refraction of the optically transmissive material may beneficially be between about 1.44 and about 1.64.

In accordance with further aspects of this particular exemplary embodiment of the present invention, the diffraction order associated with the lowest loss may beneficially be the fourth order.

In accordance with further aspects of this particular exemplary embodiment of the present invention, the reflective material may beneficially be gold material, aluminum material, or silver material.

In accordance with still other aspects of this particular exemplary embodiment of the present invention, the diffraction grating may further beneficially comprise a substantially planar substrate on which the reflective material is formed.

In still another particular exemplary embodiment, the present invention may be realized as a wavelength division device comprising a plurality of first coupling components, wherein each first component is capable of receiving a distinct carrier for carrying a signal, and a second coupling component disposed adjacent the first coupling components and capable of receiving a distinct carrier for carrying one or more signals. The wavelength division device also comprises a diffraction grating optically coupled to each carrier received by the first and second coupling components, wherein the diffraction grating comprises a blazed reflective material having a number of grooves per millimeter and a blazed angle between about 33 degrees and about 41 degrees, and an optically transmissive material disposed adjacent the reflective material having an index of refraction (n), wherein the number of grooves is approximately equal to (350±30)*n.

In accordance with other aspects of this particular exemplary embodiment of the present invention, the number of grooves per millimeter on the diffraction grating may beneficially be between about 520 and about 560 and the index of refraction may beneficially be between about 1.44 and 1.64.

In accordance with further aspects of this particular exemplary embodiment of the present invention, the diffraction order associated with the lowest loss may beneficially be the second order.

In accordance with additional aspects of this particular exemplary embodiment of the present invention, the diffraction grating may beneficially have an efficiency of at least 75% over the C-band wavelength range.

In yet another particular exemplary embodiment, the present invention may be realized as a wavelength division device comprising a plurality of first coupling components, wherein each first component is capable of receiving a distinct carrier for carrying a signal, and a second coupling component disposed adjacent the first coupling components and capable of receiving a distinct carrier for carrying one or more signals. The wavelength division device also comprises a diffraction grating optically coupled to each carrier received by the first and second coupling components, wherein the diffraction grating comprises a blazed reflective material having a number of grooves per millimeter and a blazed angle between about 32 degrees and about 40 degrees, and an optically transmissive material disposed adjacent the reflective material having an index of refraction (n), wherein the number of grooves is approximately equal to (175±30)*n.

In accordance with other aspects of this particular exemplary embodiment of the present invention, the number of grooves per millimeter on the diffraction grating may beneficially be between about 240 and about 300.

In accordance with further aspects of this particular exemplary embodiment of the present invention, the diffraction order associated with the lowest loss may beneficially be the fourth order.

In accordance with additional aspects of this particular exemplary embodiment of the present invention, the diffraction grating may beneficially have an efficiency of at least 70% over the C-band wavelength range.

In still yet another particular exemplary embodiment, the present invention may be realized as a wavelength division device comprising a means for receiving one or more input optical signals, a diffraction grating optically coupled to the means for receiving, and a means for coupling each optical signal diffracted by the diffraction grating onto one or more optical output signals, wherein the diffraction grating comprises a blazed reflective material having a number of grooves per millimeter and a blazed angle between about 33 degrees and about 41 degrees, and an optically transmissive material disposed adjacent the reflective material having an index of refraction (n), wherein the number of grooves is approximately equal to (350±30)*n.

In accordance with other aspects of this particular exemplary embodiment of the present invention, the number of grooves per millimeter on the diffraction grating may beneficially be between about 520 and 560 and the index of refraction may beneficially be between about 1.44 and about 1.64.

In still yet another particular exemplary embodiment, the present invention may be realized as a communications apparatus utilizing optical communication comprising a plurality of carriers, and a wavelength division device, wherein the wavelength division device comprises a plurality of first coupling components, wherein each first component couples a distinct carrier for carrying at least one signal within the wavelength division device. The wavelength division device also comprises a second coupling component disposed adjacent the first coupling components and coupling a distinct carrier for carrying one or more signals within the wavelength division device, and a diffraction grating disposed relative to and in optical communication with the carriers coupled to the first and second coupling components so as to diffract one or more input optical rays as a plurality of output optical rays over a wavelength range of at least approximately 30 nm. The diffraction grating comprises a blazed reflective material having a number of grooves per millimeter and a blazed angle between about 32 degrees and about 40 degrees, and an optically transmissive material disposed adjacent the reflective material having an index of refraction (n), wherein the number of grooves is approximately equal to (175±30)*n.

In accordance with other aspects of this particular exemplary embodiment of the present invention, the number of grooves per millimeter on the diffraction grating may beneficially be between about 240 and 300.

The present invention will now be described in more detail with reference to exemplary embodiments thereof as shown in the accompanying drawings. While the present invention is described below with reference to exemplary embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be exemplary only.

FIGS. 1A and 1B illustrate diffraction grating profiles according to various embodiments of the present invention.

FIGS. 2-10 are graphs showing the efficiencies of the various diffraction gratings according to embodiments of the present invention.

FIG. 11 is a side elevational view of a wave division multiplexing/demultiplexing device according to an embodiment of the present invention.

FIG. 12A is a perspective view of a portion of the wave division multiplexing/demultiplexing device of FIG. 11.

FIG. 12B is an end view of the portion of the wave division multiplexing/demultiplexing device of FIG. 11.

FIGS. 13A-13D illustrate multiplexing and demultiplexing functions of the wave division multiplexing/demultiplexing device of FIG. 11.

FIG. 14 is a block diagram of an optical communications system according to an embodiment of the present invention.

FIGS. 15A-15C illustrate the general concepts relating to diffraction gratings.

### DETAILED DESCRIPTION OF EXEMPLARY EMBODIMENTS

Optical networks are utilized to handle telecommunications traffic caused in part by the Internet, mobile communications, and facsimile communications. To increase the bandwidth of optical networks, polychromatic fiber optic lines and/or carriers have been developed to allow for multiple signals to be carried by a single fiber optic line. A central component utilized in fiber optic communication is a wavelength division multiplexer/demultiplexer (WDM). WDM devices transmit polychromatic optical signals into and receive polychromatic optical signals from polychromatic fiber optic lines. Within the WDM, a diffraction grating is utilized to join a multiple number of narrowband optical signals into a polychromatic optical signal in the multiplexing case, and separate a polychromatic optical signal into a multiple number of narrowband optical signals in the demultiplexing case. So that the WDM provides for high efficiency, embodiments of the present invention include a diffraction grating that is polarization insensitive.

In practice, narrowband optical signals or beams are not truly monochromatic, but rather a tight range of wavelengths. Each signal is defined by a narrow passband and has a center wavelength which is the representative wavelength to which an optical signal is associated. Each center wavelength is generally predefined, and may correspond with an industry standard, such as the standards set by the International Telecommunication Union.

An optics device may be described as being “polarization insensitive” if the power levels of the polarization states of one or more optical signals emitted from the device is the same as the power levels of polarization states of corresponding optical input signal(s) to the device. In other words, the device provides equal efficiency for both of the polarization states of the output optical signal(s) emitted from the device. A device is “substantially polarization insensitive” if the power levels of the polarization states of output optical signal(s) emitted from the device are within approximately 20% of the power levels of the corresponding polarization states of input optical signal(s) to the device.

Further, the term “apolarized” is used below in describing the various embodiments of the present invention as meaning a signal condition in which the power of the transverse electric polarization state TE is equal to the power of the transverse magnetic polarization state TM at a pertinent wavelength or set of wavelengths. The term “substantially apolarized” is used below as referring to a signal condition in which the power of the transverse electric polarization state TE and the power of the transverse magnetic polarization state TM are within about 20% of each other at a pertinent wavelength or set of wavelengths. The term “efficiency” used below refers to a characteristic of an optical device. In particular, “efficiency” is used to mean the gain/loss of an optical signal or signal component generated from the optical device, relative to an optical signal received thereat. The term “polarization dependent loss” or “PDL” refers to a characteristic of an optical device, and is used below to mean the maximum deviation in gain/loss across all input polarization states.

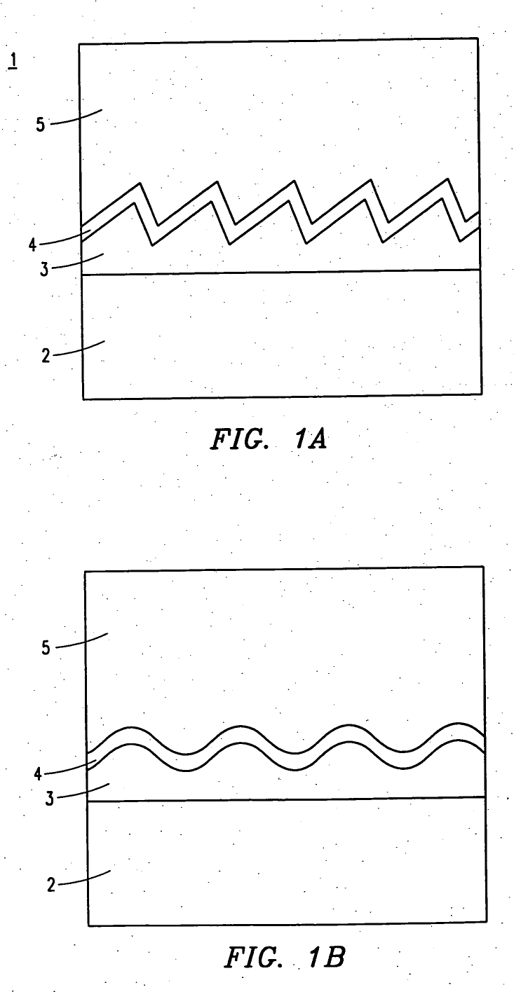

Referring to FIGS. 1A and 1B, there is shown a diffraction grating 1 according to embodiments of the present invention. Diffraction grating 1 is utilized in performing wavelength division multiplexing and demultiplexing operations, as described in greater detail below. Diffraction grating 1 may be a reflective grating so that optical and/or light rays are reflected or diffracted therefrom. Diffraction grating 1 may include a substrate 2 over which the diffractive surface of diffraction grating 1 is formed. Substrate 2 may be constructed from a number of different substances. For example, substrate 2 may be a glass compound. As shown in FIGS. 1A and 1B, substrate 2 may have a substantially planar shape. It is understood, however, that substrate 2 may alternatively include a substantially curved or concave surface (not shown) over which a diffraction grating surface is formed.

Diffraction grating 1 may further include a grating layer 3 which is formed over and/or bonded to a surface of substrate 2. An exposed surface of grating layer 3 may have a grating profile. The grating profile of grating layer 3 may be formed a number of different ways, including the utilization of ruling or holographic techniques, as is known in the art. The particular grating profiles and corresponding characteristics of grating layer 3 according to the embodiments of the present invention will be described in greater detail below.

A reflective layer 4 is formed over and/or bonded to the exposed surface of grating layer 3. Reflective layer 4 substantially forms the particular grating profile of grating layer 3. Reflective layer 4 may be a metal composition, such as gold, aluminum or silver.

An optically transmissive material or coating 5 may be disposed over or adjacent reflective layer 4. Material 5 is utilized to increase the reflectivity of diffraction grating 1. Material 5 is shown in FIG. 1A as being formed directly over reflective material 4. It is understood, however, that an additional layer (not shown), such as a bonding agent having a different index of refraction relative to material 5, may be disposed between material 5 and reflective layer 4.

It is understood that diffraction grating 1 may include additional or fewer layers than described above. For example, a surface of substrate 2 may be worked so as to form a grating profile thereon, and reflective layer 4 bonded to or formed directly on substrate 2. Alternatively, a thickness of reflective layer 4 may be sufficiently dimensioned so that a surface of reflective layer 4 may be worked to form a grating profile thereon, thereby rendering substrate 2 and grating layer 3 unnecessary. Diffraction grating 1, however, will be presented as a three layer diffraction grating for exemplary purposes.

The grating profile of diffraction grating 1 is characterized to provide enhanced optical communication. The enhanced optical communication performance of diffraction grating 1 is based upon a certain combination of parameters which define the grating profile of diffraction grating 1. As shown in FIG. 1A and in accordance with an embodiment “A”, diffraction grating 1 is a blazed grating type. The blaze angle of diffraction grating 1 is between about twenty-seven (27) and about thirty-nine (39) degrees. The number of grooves 9 per millimeter of diffraction grating 1 may be generally defined by the equation:

(500±110)*n

where n is the index of refraction of material 5. The number of grooves per millimeter may be more particularly defined between: about 700 and about 800 when the index of refraction n of material 5 is between about 1.44 and about 1.64 and the blaze angle is between about 27 and 32 degrees; between about 850 and 950 when the index of refraction n of material 5 is between about 1.44 and about 1.64 and the blaze angle is between about 31 and 34 degrees; and between about 950 and 1050 when the index of refraction n of material 5 is between about 1.44 and about 1.64 and the blaze angle is between about 34 and 39 degrees. In addition, the diffraction order utilized with embodiment A of diffraction grating 1 is the first order. The particular parameter values for embodiment A of diffraction 10 are summarized below in the following Table.

TABLE
DIFFRACTION GRATING PARAMETERS

| | | | | | Index of | | |
|---|---|---|---|---|---|---|---|
| | | | | | refraction | | |
| | | | | | of immersed | | |
| | | | | Groove | grating | blaze | |
| | Grating | Reflection | Grooves per | Depth | medium | angle | diff. |
| | Type | Surface | Millimeter | (nm) | (typical) | (degs) | order |
| A | blazed | aluminum or | 750 ± 50 | — | 1.44-1.64 | 27-32 | 1 |
| | | gold | 900 ± 50 | 1.44-1.64 | 31-34 | | |
| | | | 1000 ± 50 | 1.44-1.64 | 34-39 | | |
| | | | (500 ± 110)n | | | | |
| B | sinusoidal | aluminum or | 750 ± 50 | 420-470 | 1.44-1.64 | — | 1 |
| | | gold | (500 ± 110)n | (685 ± 40)/n | | | |
| C | blazed | aluminum or | 300 ± 40 | — | 1.44-1.64 | 37-40 | 4 |
| | | gold | (200 ± 40)n | | | | |
| D | blazed | aluminum or | 600 ± 40 | — | 1.44-1.64 | 41-44 | 2 |
| | | gold | (450 ± 40)n | | | | |
| E | blazed | aluminum or | 200 ± 20 | — | 1.0 (air) | 68-76 | 5 |
| | | gold | (200 ± 20)n | | | | |
| F | blazed | aluminum or | 250 ± 30 | — | 1.0 (air) | 50-56 | 4 |
| | | gold | (250 ± 0)n | | | | |
| G | blazed | aluminum or | 540 ± 20 | — | 1.44-1.64 | 33-41 | 2 |
| | | gold | (350 ± 30)n | | | | |
| H | blazed | aluminum or | 270 ± 30 | — | 1.44-1.64 | 32-40 | 4 |
| | | gold | (175 ± 30)n | | | | |

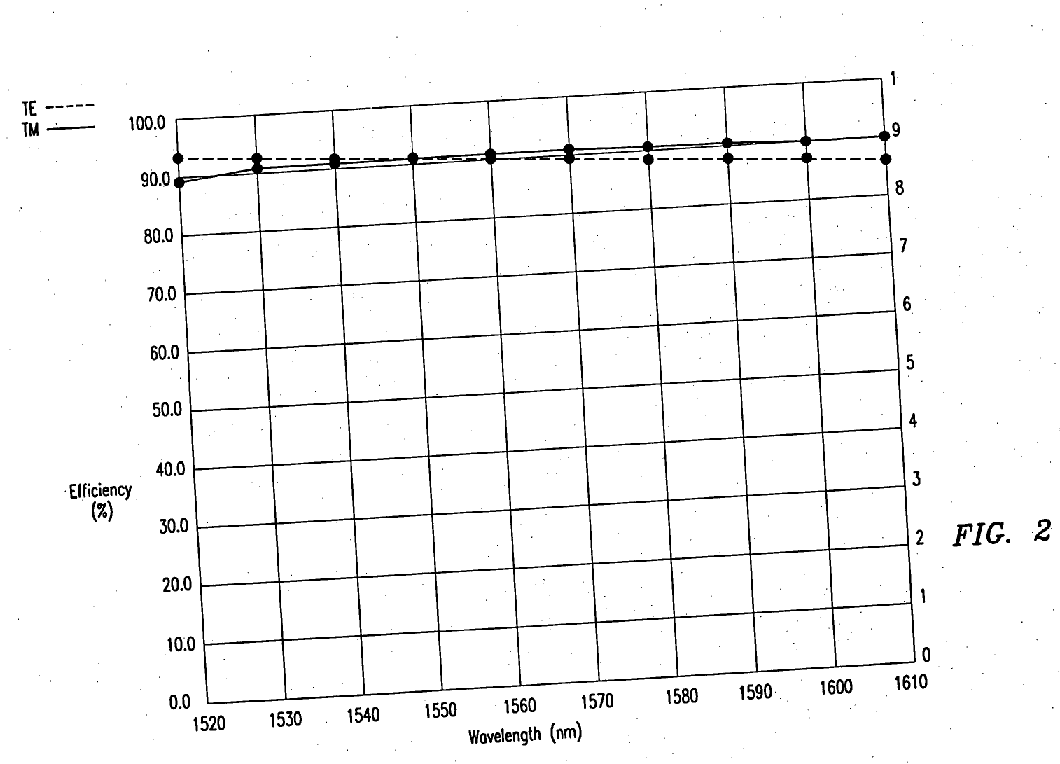

FIG. 2 illustrates the resulting performance of embodiment A of diffraction grating 1 having the grating parameter values described above, based upon receiving an apolarized optical signal as an input. As can be seen, the efficiency of both the transverse electric polarization state TE and the transverse magnetic polarization state TM exceed 80% (the PDL being as low as 0.25 dB) over both the C-band and L-band wavelength ranges. Further, because the efficiencies of transverse electric polarization state TE and transverse magnetic polarization state TM are substantially the same across the C-band wavelength range and the L-band wavelength range, diffraction grating 1 diffracts substantially apolarized optic rays in response to the apolarized input optical signal. Consequently, diffraction grating 1 is substantially polarization insensitive across the C-band wavelength range (about 1520 nm to about 1566 nm) and the L-band wavelength range (about 1560 nm to about 1610 nm).

Still further, the cross-over point for the efficiency of the transverse electric polarization state TE and the efficiency of the transverse magnetic polarization state TM occurs in the C-band wavelength range, and particularly in the upper half thereof. The high efficiency combined with the location of the efficiency cross-over location result in diffraction grating 1 providing enhanced optical performance in both the C-band and L-band wavelength ranges.

In accordance with another diffraction grating embodiment, FIG. 1B shows the profile of embodiment “B” of a diffraction grating 1 of the sinusoidal grating type. The groove depth d of diffraction grating 1 of embodiment B may be generally defined by the equation:

(685±40)/n

where n is the index of refraction of material 5. The groove depth may be more particularly defined between about 420 nm and about 470 nm when material 5 has an index of refraction between about 1.44 and about 1.64. The number of grooves g per millimeter of diffraction grating 1 may be generally defined by the equation:

(500±110)*n

and more particularly defined between about 700 and about 800 when material 5 has an index of refraction between about 1.44 and about 1.64. In addition, the diffraction order utilized with embodiment B of diffraction grating 1 is the first order. The particular parameter values for embodiment B of diffraction 10 are summarized in the Table.

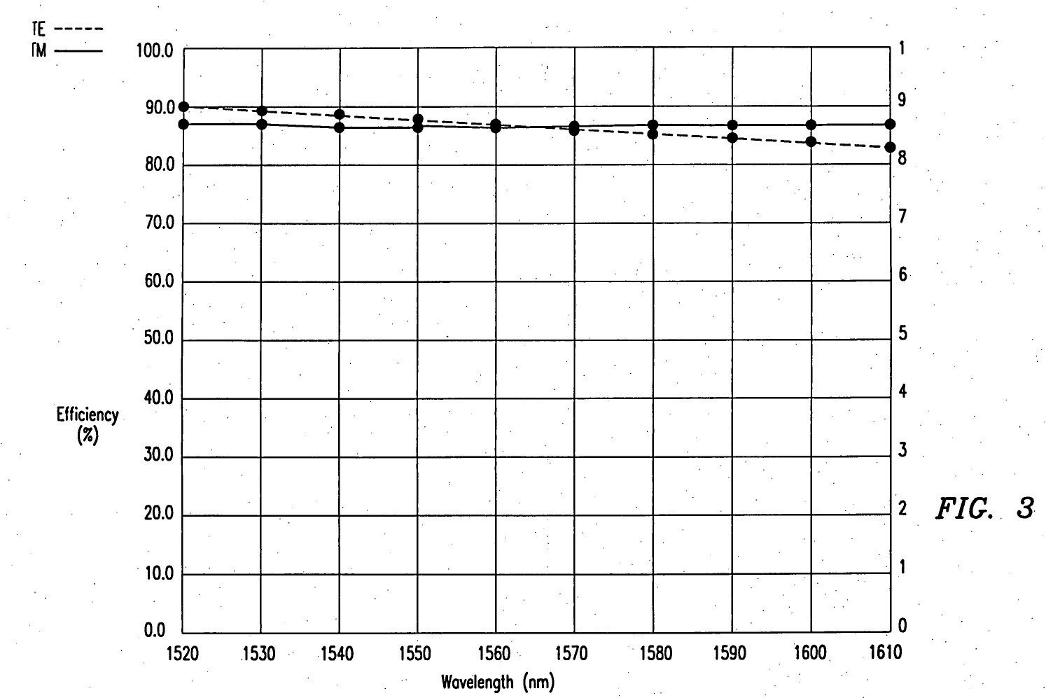

FIG. 3 illustrates the resulting performance of embodiment B of diffraction grating 1 having the grating parameter values described above, based upon receiving an apolarized optical signal as an input. As can be seen, the efficiency of both the transverse electric polarization state TE and the transverse magnetic polarization state TM exceed 80% over the C-band and L-band wavelength ranges. Further, because the efficiencies of transverse electric polarization state TE and transverse magnetic polarization state TM are substantially the same and/or closely follow each other across the C-band and L-band wavelength ranges, diffraction grating 1 diffracts substantially apolarized optic rays in response to the apolarized input optical signal. Consequently, diffraction grating 1 is substantially polarization insensitive across the C-band and L-band wavelength ranges.

Still further, the cross-over point for the efficiency of the transverse electric polarization state TE and the efficiency of the transverse magnetic polarization state TM occurs in the C-band wavelength range, and particularly in the upper end thereof. The high efficiency combined with the location of the efficiency cross-over point result in diffraction grating 1 providing enhanced optical performance in both the C-band wavelength range and the L-band wavelength ranges.

In accordance with another diffraction grating embodiment, FIG. 1A illustrates the profile of embodiment “C” of a diffraction grating 1 of the blazed grating type. The blaze angle of diffraction grating 1 is between about thirty-seven (37) and about forty (40) degrees. The number of grooves G per millimeter of diffraction grating 1 may be generally defined by the equation:

(200±40)*n

where n is the index of refraction of material 5. More specifically, the number of grooves may be between about 260 and about 340 when material 5 has an index of refraction n between about 1.44 and about 1.64. In addition, the diffraction order utilized with embodiment C of diffraction grating 1 is the fourth order. The particular parameter values for embodiment C of diffraction 10 are summarized the Table.

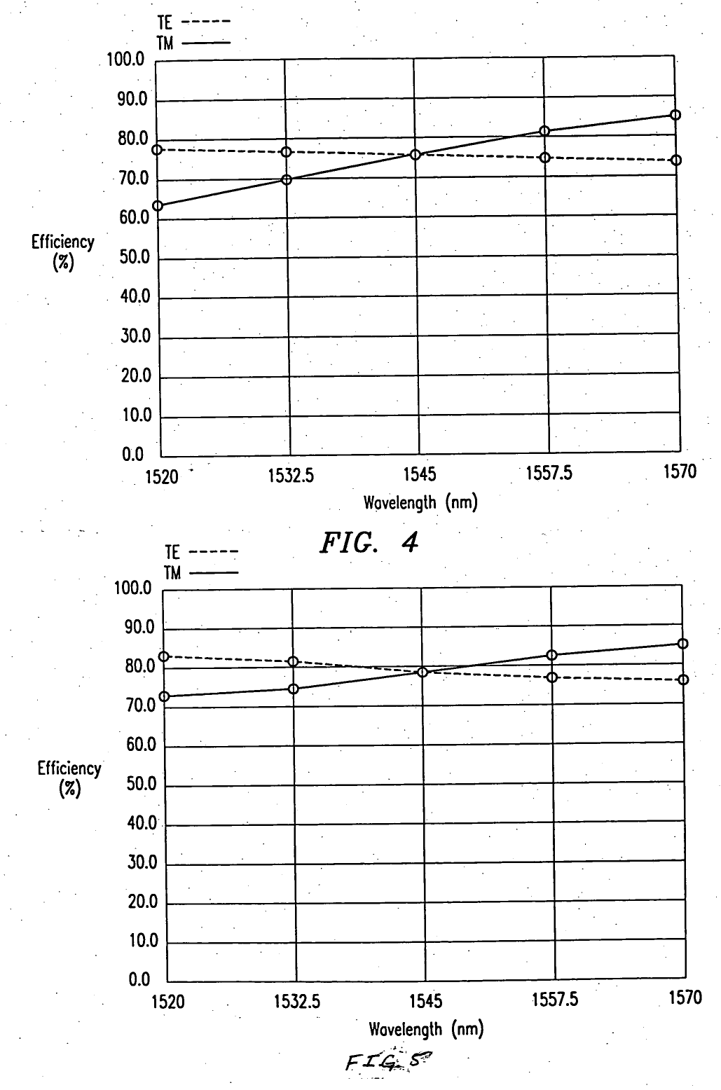

FIG. 4 illustrates the resulting performance of embodiment C of diffraction grating 1 having the grating parameter values described above, based upon receiving an apolarized optical signal as an input. As can be seen, the efficiency of both the transverse electric polarization state TE and the transverse magnetic polarization state TM exceed 60% over the C-band wavelength range. Further, because the efficiencies of transverse electric polarization state TE and transverse magnetic polarization state TM somewhat closely follow each other across the C-band wavelength range, embodiment C of diffraction grating 1 diffracts substantially apolarized optic rays in response to the apolarized input optical signal.

Still further, the cross-over point for the efficiency of the transverse electric polarization state TE and the efficiency of the transverse magnetic polarization state TM occurs in the C-band wavelength range, and particularly around the midpoint thereof. The high efficiency combined with the location of the efficiency cross-over point result in diffraction grating 1 providing enhanced optical performance in the C-band wavelength range.

In accordance with another diffraction grating embodiment, FIG. 3A shows the profile of embodiment “D” of a diffraction grating 1 of the blazed grating type. The blaze angle of embodiment D of diffraction grating 1 is between about forty-one (41) and about forty-four (44) degrees. The number of grooves G per millimeter of diffraction grating 1 may be generally defined by the equation:

(450±40)*n

where n is the index of refraction of material 5. More specifically, the number of grooves may be between about 560 and about 640 when material 5 has an index of refraction n between about 1.44 and about 1.64. In addition, the diffraction order utilized with embodiment D of diffraction grating 1 is the second order. The particular parameter values for embodiment D of diffraction 10 are summarized in the Table.

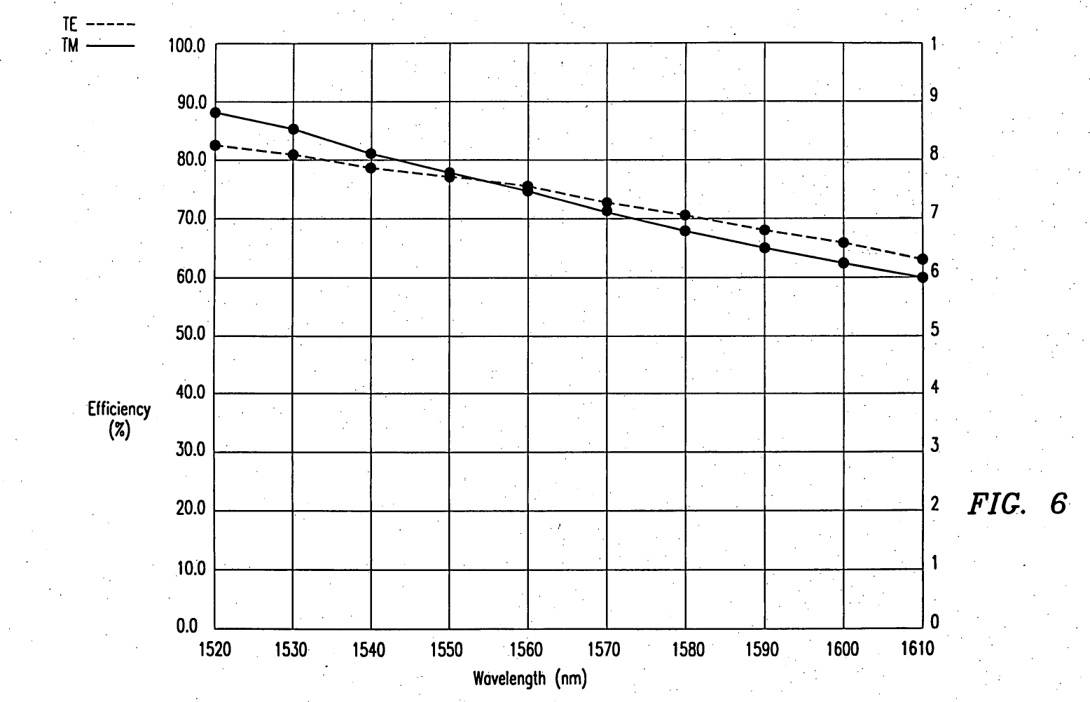

FIG. 5 illustrates the resulting performance of embodiment D of diffraction grating 1 having the grating parameter values described above, based upon receiving an apolarized optical signal as an input. As can be seen, the efficiency of both the transverse electric polarization state TE and the transverse magnetic polarization state TM exceed 70% over the C-band wavelength range. Further, because the efficiencies of transverse electric polarization state TE and transverse magnetic polarization state TM somewhat closely follow each other across the C-band wavelength range embodiment D of diffraction grating 1 diffracts substantially apolarized optic rays in the C-band wavelength range in response to the apolarized input optical signal.

In accordance with another diffraction grating embodiment, FIG. 3A shows the profile of embodiment “E” of a diffraction grating 1 of the blazed grating type. The blaze angle of embodiment E of diffraction grating 1 is between about sixty-eight (68) and about seventy-six (76) degrees. The number of grooves G per millimeter of embodiment E of diffraction grating 1 may be generally defined by the equation:

(200±20)*n

where n is the index of refraction of material 5. More specifically, the number of grooves may be between about 180 and about 220 when material 5 is air or otherwise has an index of refraction of about 1.0. In addition, the diffraction order utilized with embodiment E of diffraction grating 1 is the fifth order. The particular parameters for embodiment E of diffraction 10 are summarized in the Table.

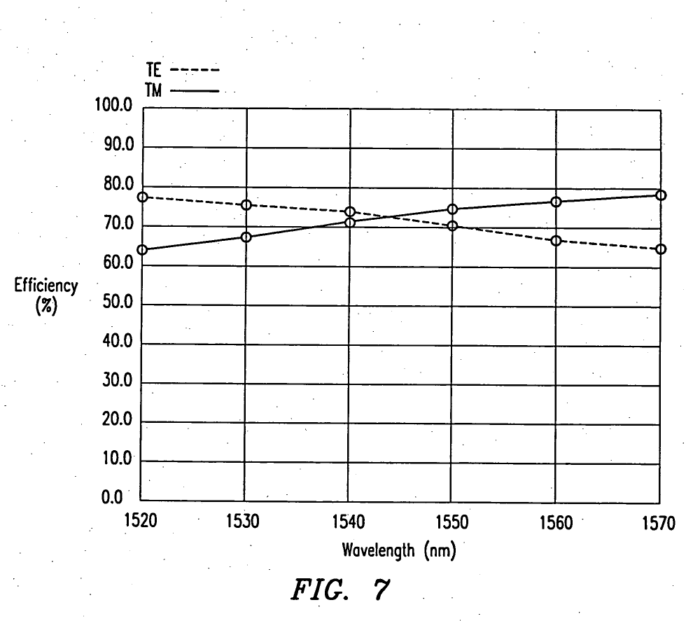

FIG. 6 illustrates the resulting performance of embodiment E of diffraction grating 1 having the grating parameter values described above, based upon receiving an apolarized optical signal as an input. As can be seen, the efficiency of both the transverse electric polarization state TE and the transverse magnetic polarization state TM exceed 70% over the C-band wavelength range, and exceed 60% over the L-band wavelength range. Further, because the efficiencies of transverse electric polarization state TE and transverse magnetic polarization state TM somewhat closely follow each other across the C-band and L-band wavelength ranges, embodiment E of diffraction grating 1 diffracts substantially apolarized optic rays across the C-band and L-band wavelength ranges in response to the apolarized input optical signal. Still further, the cross-over point for the efficiency of the transverse electric polarization state TE and the efficiency of the transverse magnetic polarization state TM occurs in the C-band wavelength range, and particularly around the midpoint thereof. The high efficiency combined with the location of the efficiency cross-over point result in embodiment E of diffraction grating 1 providing enhanced optical performance in both the C-band wavelength range and the L-band wavelength range.

In accordance with another diffraction grating embodiment, FIG. 3A shows the profile of embodiment “F” of a diffraction grating 1 of the blazed grating type. The blaze angle of embodiment F of diffraction grating 1 is between about fifty (50) and about fifty-six (56) degrees. The number of grooves G per millimeter of embodiment F of diffraction grating 1 may be generally defined by the equation:

(250±30)*n

where n is the index of refraction of material 5. More specifically, the number of grooves may be between about 220 and about 280 when material 5 is air or otherwise has an index of refraction of about 1.0. In addition, the diffraction order utilized with embodiment E of diffraction grating 1 is the fourth order. The particular parameters for embodiment E of diffraction 10 are summarized in the Table.

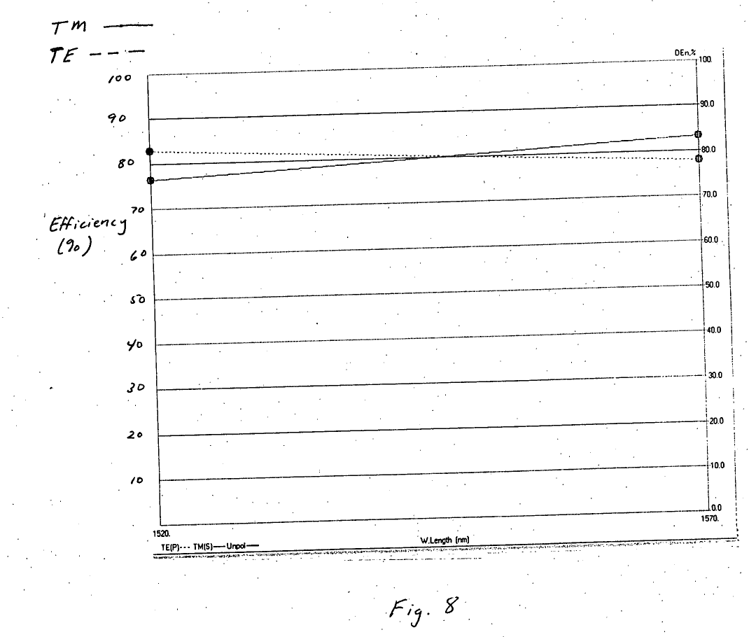

FIG. 7 illustrates the resulting performance of embodiment F of diffraction grating 1 having the grating parameter values described above, based upon receiving an apolarized optical signal as an input. As can be seen, the efficiency of both the transverse electric polarization state TE and the transverse magnetic polarization state TM exceed 60% over the C-band wavelength range. Further, because the efficiencies of transverse electric polarization state TE and transverse magnetic polarization state TM somewhat closely follow each other across the C-band wavelength range, embodiment F of diffraction grating 1 diffracts substantially apolarized optic rays in response to receiving an apolarized input optical signal. Still further, the cross-over point for the efficiency of the transverse electric polarization state TE and the efficiency for the transverse magnetic polarization state TM occurs in the C-band wavelength range, and particularly around the midpoint thereof. The high efficiency combined with the location of the efficiency cross-over point result in embodiment F of diffraction grating 1 providing enhanced optical performance in the C-band wavelength range.

In accordance with a first exemplary embodiment of the present diffraction grating invention, FIG. 1A illustrates the profile of embodiment “G” of a diffraction grating 1 of the blazed grating type. The blaze angle of diffraction grating 1 is between about thirty-seven (33) and about forty (41) degrees. The number of grooves G per millimeter of diffraction grating 1 may be generally defined by the equation:

(350±20)*n

where n is the index of refraction of material 5. More specifically, the number of grooves may be between about 520 and about 560 when material 5 has an index of refraction n between about 1.44 and about 1.64. In addition, the diffraction order utilized with embodiment G of diffraction grating 1 is the second order. The particular parameter values for embodiment G of diffraction 10 are summarized the Table.

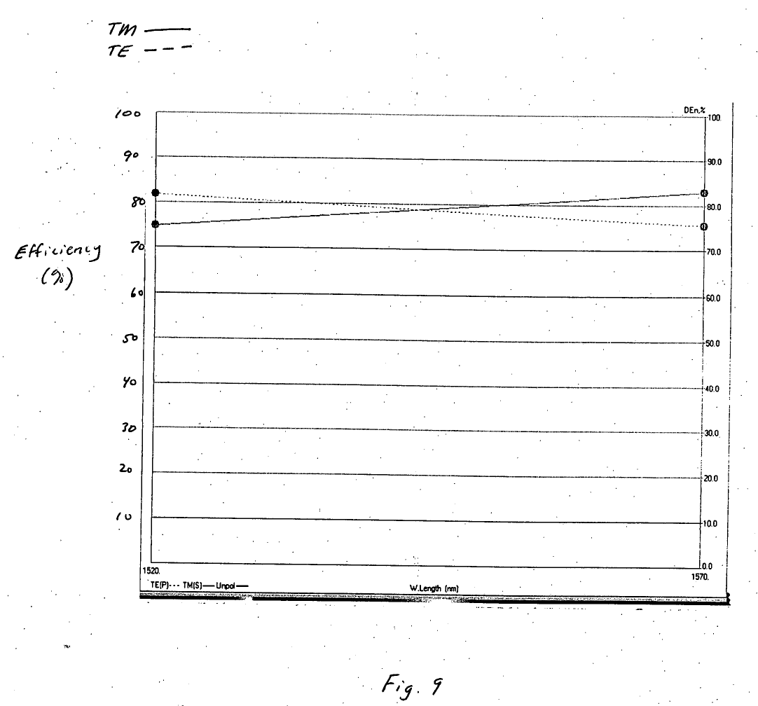

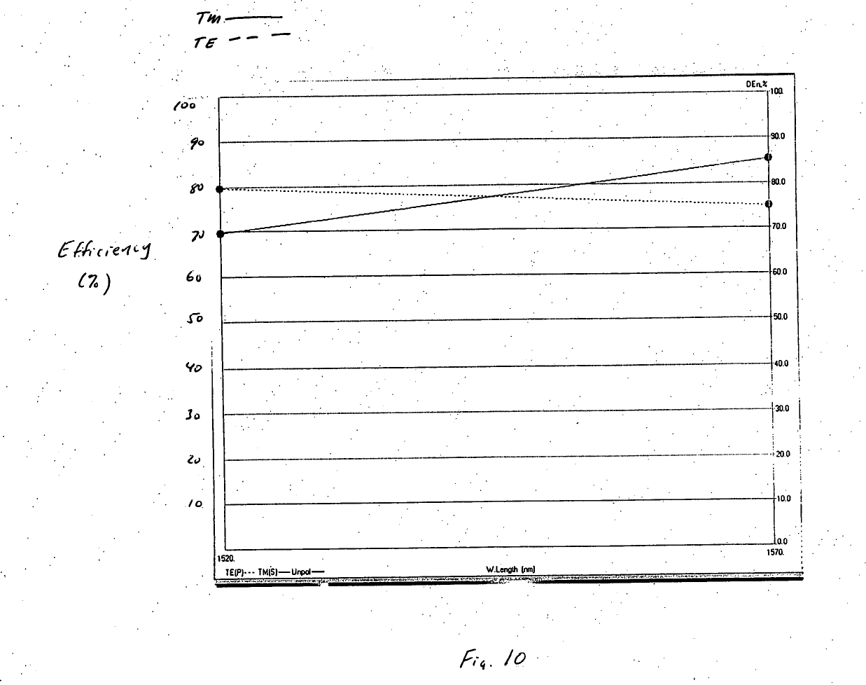

FIG. 8 illustrates the resulting performance of embodiment G of diffraction grating 1 having a blaze angle of about 36 degrees and an index of refraction of about 1.544, based upon receiving an apolarized optical signal as an input. FIG. 9 illustrates the resulting performance of embodiment G of diffraction grating 1 having a blaze angle of about 37.2 degrees and an index of refraction of about 1.49, based upon receiving an apolarized optical signal as an input. As can be seen, the efficiency of both the transverse electric polarization state TE and the transverse magnetic polarization state TM exceed 75% over the C-band wavelength range. Further, because the efficiencies of transverse electric polarization state TE and transverse magnetic polarization state TM somewhat closely follow each other across the C-band wavelength range, embodiment G of diffraction grating 1 diffracts substantially apolarized optic rays in response to the apolarized input optical signal.

Still further, the cross-over point for the efficiency of the transverse electric polarization state TE and the efficiency of the transverse magnetic polarization state TM occurs in the C-band wavelength range, and particularly around the midpoint thereof. The high efficiency combined with the location of the efficiency cross-over point result in diffraction grating 1 providing enhanced optical performance in the C-band wavelength range.

In accordance with a second exemplary embodiment of the present diffraction grating invention, FIG. 1A illustrates the profile of embodiment “H” of a diffraction grating 1 of the blazed grating type. The blaze angle of diffraction grating 1 is between about thirty-seven (32) and about forty (40) degrees. The number of grooves G per millimeter of diffraction grating 1 may be generally defined by the equation:

(175±30)*n

where n is the index of refraction of material 5. More specifically, the number of grooves may be between about 240 and about 300 when material 5 has an index of refraction n between about 1.44 and about 1.64. In addition, the diffraction order utilized with embodiment H of diffraction grating 1 is the fourth order. The particular parameter values for embodiment H of diffraction 10 are summarized the Table.

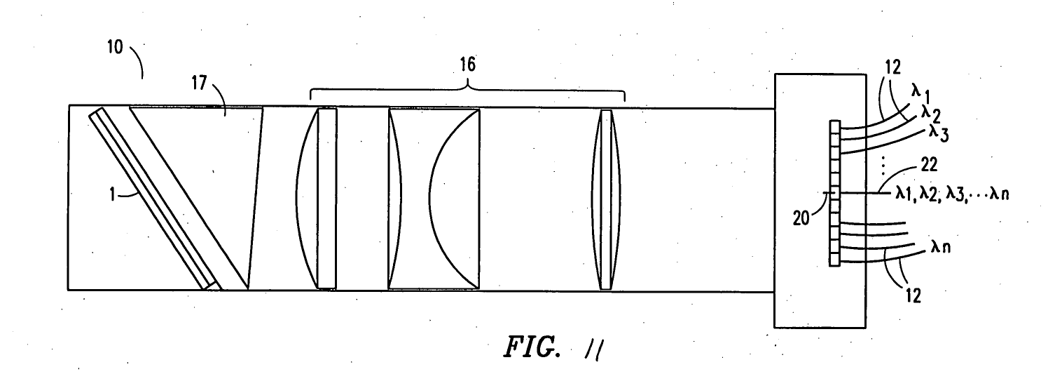

FIG. 10 illustrates the resulting performance of embodiment H of diffraction grating 1 having a blaze angle of about 35.3 and an index of refraction of about 1.49, based upon receiving an apolarized optical signal as an input. As can be seen, the efficiency of both the transverse electric polarization state TE and the transverse magnetic polarization state TM exceed 70% over the C-band wavelength range. Further, because the efficiencies of transverse electric polarization state TE and transverse magnetic polarization state TM somewhat closely follow each other across the C-band wavelength range, embodiment H of diffraction grating 1 diffracts substantially apolarized optic rays in response to the apolarized input optical signal.

Still further, the cross-over point for the efficiency of the transverse electric polarization state TE and the efficiency of the transverse magnetic polarization state TM occurs in the C-band wavelength range, and particularly around the midpoint thereof. The high efficiency combined with the location of the efficiency cross-over point result in diffraction grating 1 providing enhanced optical performance in the C-band wavelength range.

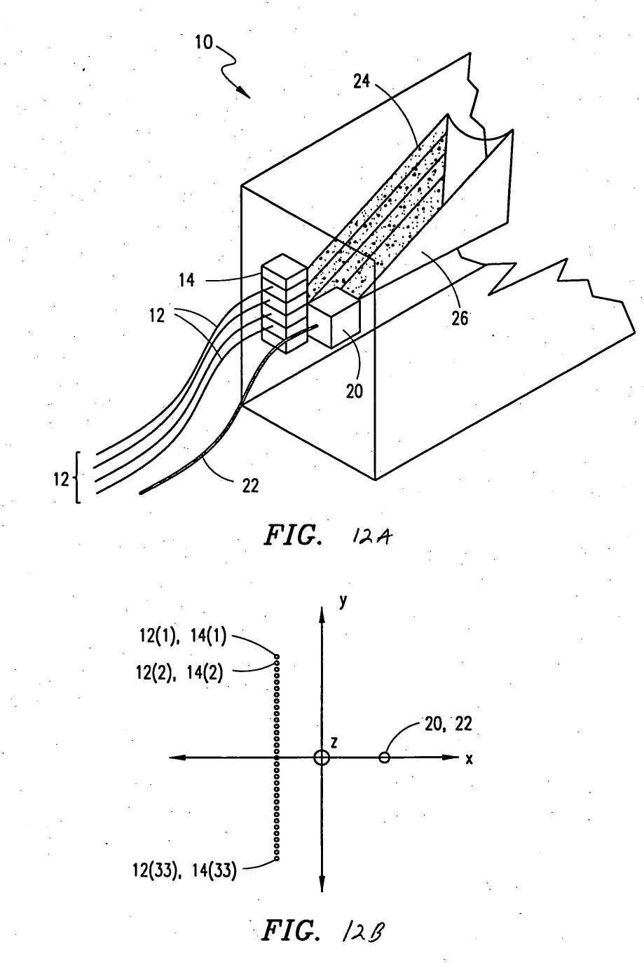

Referring to FIG. 11, there is shown a side view of an exemplary embodiment of a wavelength division multiplexing/demultiplexing (WDM) device 10 in accordance with the present invention. The WDM device 10 comprises a plurality of first optical fiber lines or carriers 12, a corresponding plurality of first coupling components 14, a collimating/focusing lens 16 assembly, a prism 17, reflective diffraction grating 1, a second coupling component 20, and a corresponding second optical fiber line or carrier 22. All of the above-identified components of the WDM device 10 are disposed along an optical axis X-X of the WDM 10, as will be described in more detail below.

End portions of the plurality of first optical fiber lines or carriers 12 are grouped into a one-dimensional fiber array (i.e., a 1×4 array) by the first coupling components 14, while an end portion of the single second optical fiber 22 is secured to the output fiber coupling component 20. Both the first coupling components 14 and the second coupling component 20 are used for purposes of optical fiber securement, ease of optical fiber handling and precision optical fiber placement within WDM device 10. First and second coupling components may be, for example, a silicon V-groove assembly.

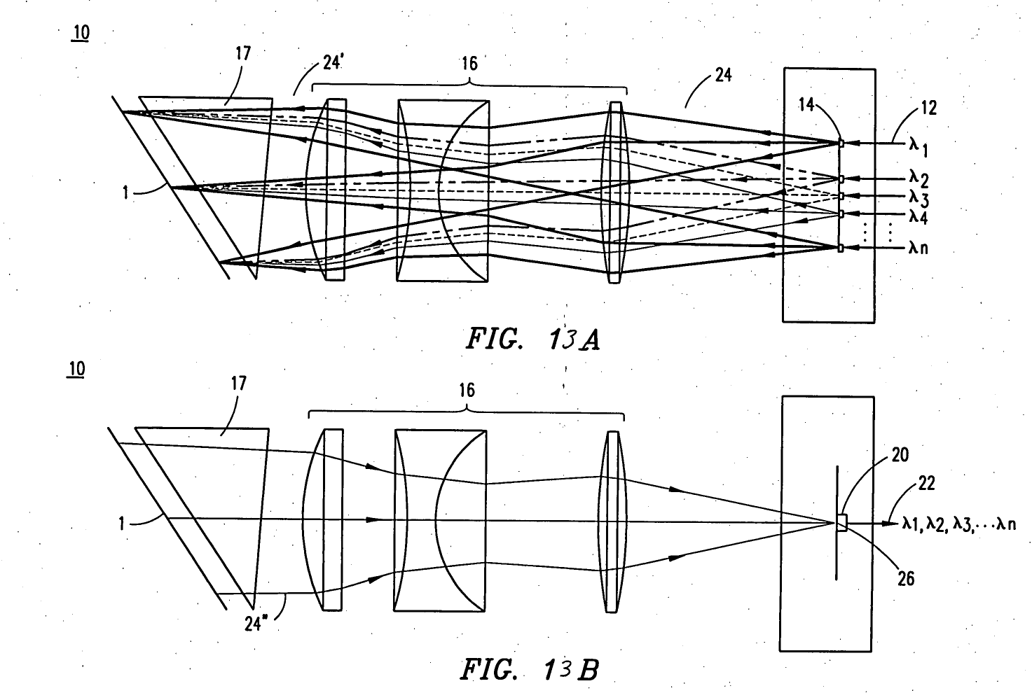

Referring to FIG. 12A, there is shown a perspective end view of a portion of the WDM device 10 revealing how the plurality of first optical fibers 12 are grouped into the one-dimensional fiber array by the first coupling components 14, and how the single second optical fiber 22 is secured to the second coupling component 20.

As shown in FIG. 12B, the first coupling components 14 and the second coupling component 20 are disposed offset from, but symmetrically about, the optical axis X-X of the multiplexing device 10 so as to avoid signal interference between a polychromatic optical beam 26 appearing on or directed to second optical fiber 22 and a narrowband optical beam 24 appearing on or directed to any of the plurality of first optical fibers 12, or anywhere else. This offset spacing of the first coupling components 14 from the second coupling component 20 is determined based upon the characteristics of diffraction grating 1, the wavelengths of each of the narrowband optical beams 24, and the focusing power of lens assembly 16.

Lens assembly 16 (FIG. 11) is adapted to collimate narrowband optical beams 24 incident thereon. Lens assembly 16 has a relatively high level of transmission efficiency. The lens assembly may include a plano-convex homogeneous refractive index collimating/focusing lens assembly. Each lens in the lens assembly 16 may utilize a refraction glass material having a high index of refraction to insure efficient optic beam transmissions.

Lens assembly 16 is illustrated in the drawings as a triplet lens assembly for exemplary purposes only. It is understood that lens assembly 16 may include other lens types, lens configurations and/or lens compositions or a different number of lenses. In cases where diffraction grating 1 is concave or otherwise non-planar, the use of lens assembly 16 within WDM device 10 may be unnecessary.

Prism 17 is disposed between lens assembly 16 and diffraction grating 1. Prism 17 bends optical signals from lens assembly 16 towards diffraction grating 1. In doing so, prism 17 allows diffraction grating 1 to be angularly disposed within the housing of WDM device 10, as shown in FIG. 11. Prism 17 may be in direct contact with material 5 of diffraction grating 1, or spaced therefrom. It is understood, however, that WDM device 1 may be utilized without prism 17.

The use of the exemplary embodiments G and H of diffraction grating 1 within WDM device 10 results in a high efficiency device for performing substantially polarization insensitive multiplexing/demultiplexing operations. For instance, WDM device 10, in accordance with embodiments of the present invention, may achieve a polarization dependent loss of less than approximately 1 dB, and particularly less than 0.5 dB, with an insertion loss of less than 3 dB. Due in part to the angular dispersion provided by diffraction grating 1, WDM device 10 may handle up to 49 channels with channel spacing of approximately 0.8 nm over the C-band or L-band wavelength range. Diffraction grating 1 may be used in the Littrow mode in WDM device 10. With such high efficiency performance, the present WDM device 10 may be utilized as a passive device and in a substantially passive network. By eliminating the need for active components, WDM device 10 of the embodiments of the present invention thereby reduces power and conserves energy.

It is understood that although diffraction grating 1 may be associated with and/or included in passive devices and networks, it is understood that diffraction grating 1 may be utilized in devices and networks having active components which may perform one or more of a variety of active functions, including optical amplification.

The WDM device 10 may further include a set of patterned optical component (not shown). By way of one example, each patterned optical component may be a plano-convex converging patterned optical component having a substantially convex surface on one side with a substantially patterned phase mask superimposed, and the spacing or pitch between adjacent patterned optical components may progressively increase from one end of the one-dimensional fiber array to the other. The progressively increased pitch may be a function of the diffraction equation of diffraction grating 1. The patterned optical components are discussed in greater detail in U.S. patent application Ser. No. 09/545,826, filed Apr. 10, 2000, now U.S. Pat. No. 6,415,073, issued Jul. 2, 2002 (Client Reference No. D-99008-US; Attorney Docket No. 62687.000028), which is incorporated by reference herein in its entirety.

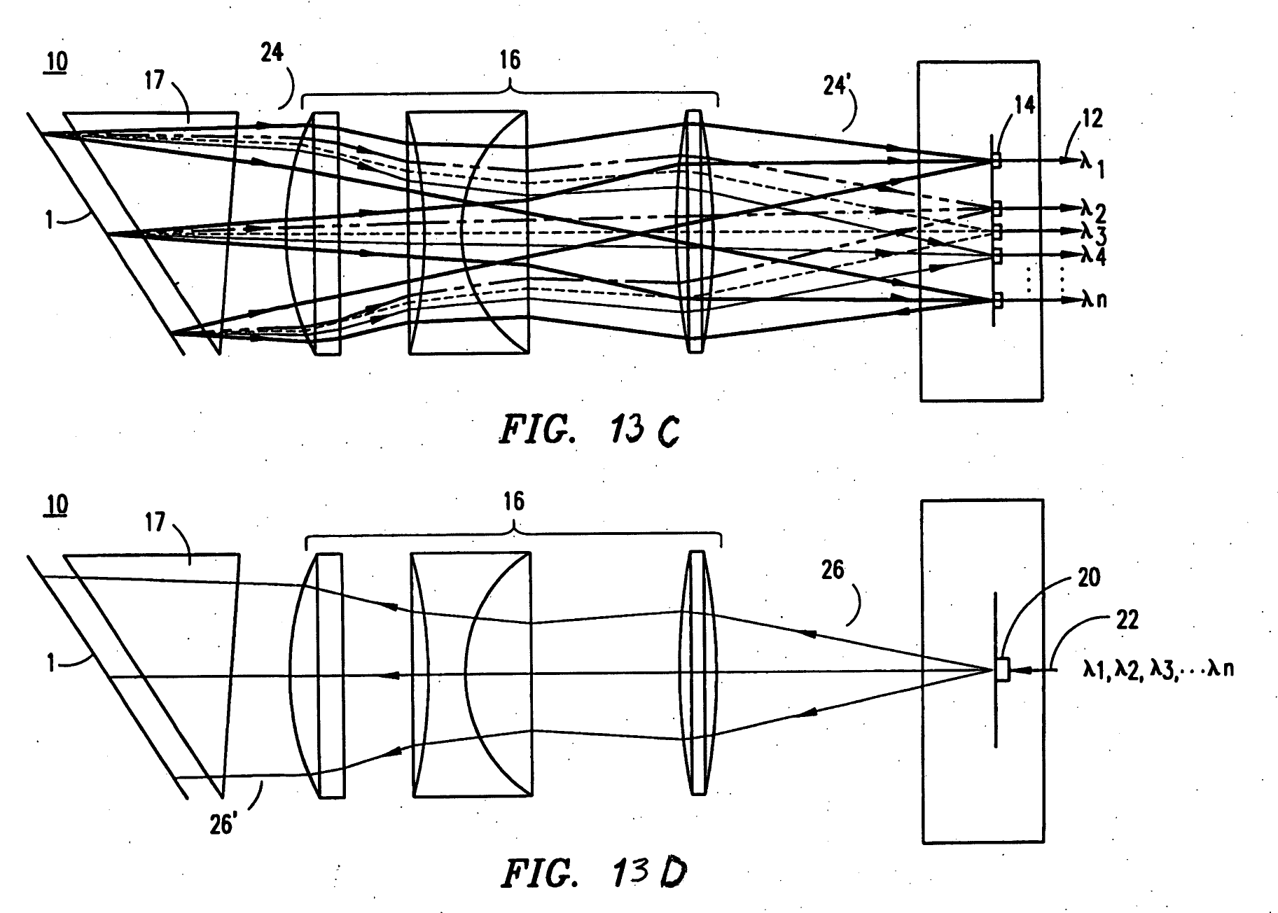

The operation of WDM device 10 will be described with reference to FIGS. 13A-13D. As mentioned above, WDM device 10 is capable of performing both multiplexing and demultiplexing functions. In the context of a multiplexing function, reference is made to FIGS. 13A and 13B.

In performing a multiplexing function, WDM device 10 generally receives a plurality of individual narrowband optical input signals or beams 24 at different wavelengths and combines such signals to generate a polychromatic output signal or beam 26. Each of the plurality of narrowband optical input beams 24 are transmitted along and emitted from a corresponding first optical fiber 12 into the air space between the first coupling components 14 and lens assembly 16. Within this air space, the plurality of narrowband optical input beams 24 are expanded in diameter (best seen in FIG. 12A) until they become incident upon the lens assembly 16. The lens assembly 16 collimates each of the plurality of narrowband optical input beams 24 (FIG. 13A), and transmits each collimated, narrowband optical input beam 24′ to the diffraction grating 1.

Referring to FIG. 13B, diffraction grating 1 operates to angularly reflect the plurality of collimated, narrowband optical input beams 24′ back towards lens assembly 16, generally shown as reflected beams 24″. In doing so, the diffraction grating 1 removes the angular or spatial separation of the plurality of collimated, narrowband optical input beams 24″. Lens assembly 16 focuses the reflected beams 24″ towards second coupling component 20. The focused reflected beams 24″ become incident upon the single second optical fiber 22 and combine in a multiplexed polychromatic optical output signal 26 at second coupling component 20. The single collimated, polychromatic optical output beam 26 contains each of the unique wavelengths of the plurality of the narrowband reflected beams 24″. The single multiplexed, polychromatic optical output beam 26 is then coupled into the single second optical fiber 22 for transmission therethrough.

In the context of performing a demultiplexing operation, the operation of WDM device 10 will be described with reference to FIGS. 13C and 13D. In performing a demultiplexing function, WDM device 10 generally receives a single polychromatic input signal or beam 26 and generates a plurality of individual narrowband optical signals or beams 24 at different wavelengths from the single polychromatic input signal 26.

A single polychromatic optical input beam 26 is transmitted along and emitted from second optical fiber 22 into the air space between the second coupling component 20 and the lens assembly 16. Within this air space, the polychromatic optical input beam 26 is expanded in diameter (best seen in FIG. 12A) until it becomes incident upon the lens assembly 16. The lens assembly 16 focuses the polychromatic optical input beam 26 towards diffraction grating 1 as polychromatic optical beam 26′ (FIG. 13C).

As stated above, diffraction grating 1 operates to angularly diffract the polychromatic optical beam 26′ into a plurality of narrowband optical beams 24, with each reflected narrowband beam 24 being diffracted at a distinct angle, relative to diffraction grating 1, by an amount that is dependent upon the wavelength of the reflected narrowband optical beam 24. As shown in FIG. 13D, the diffraction grating 1 reflects the narrowband optical signals 24 back towards the lens assembly 16. The lens assembly 16 collimates the plurality of narrowband optical input beams 24, and then transmits each collimated, narrowband optical beam 24′ to the corresponding first coupling component 14 and corresponding first optical fiber 12. Each narrowband optical beam 24′ becomes incident upon a corresponding first optical fiber 12. At this point, the narrowband optical signals 24′ are then coupled to the first optical fibers 12 for transmission therethrough.

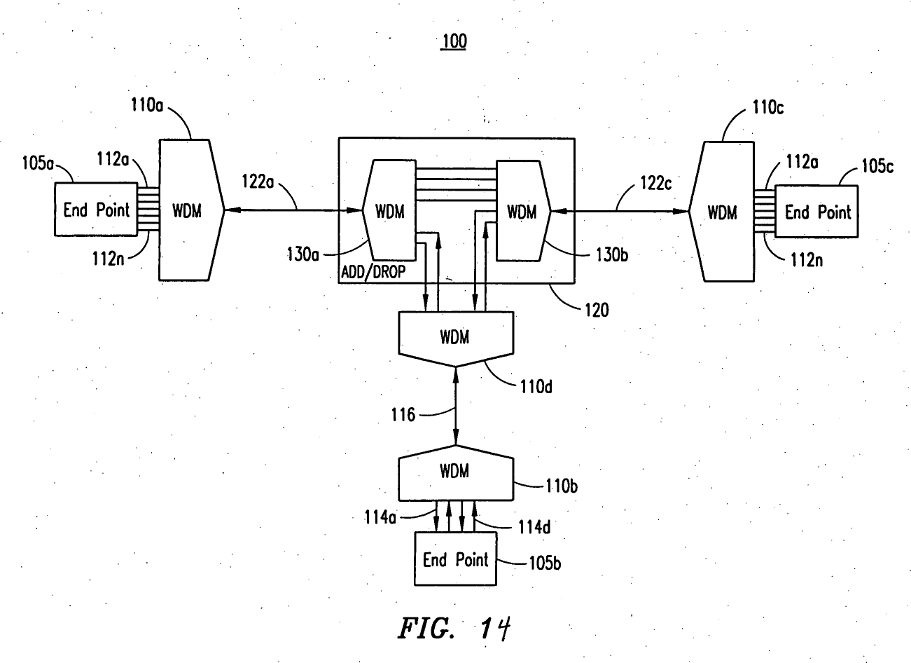

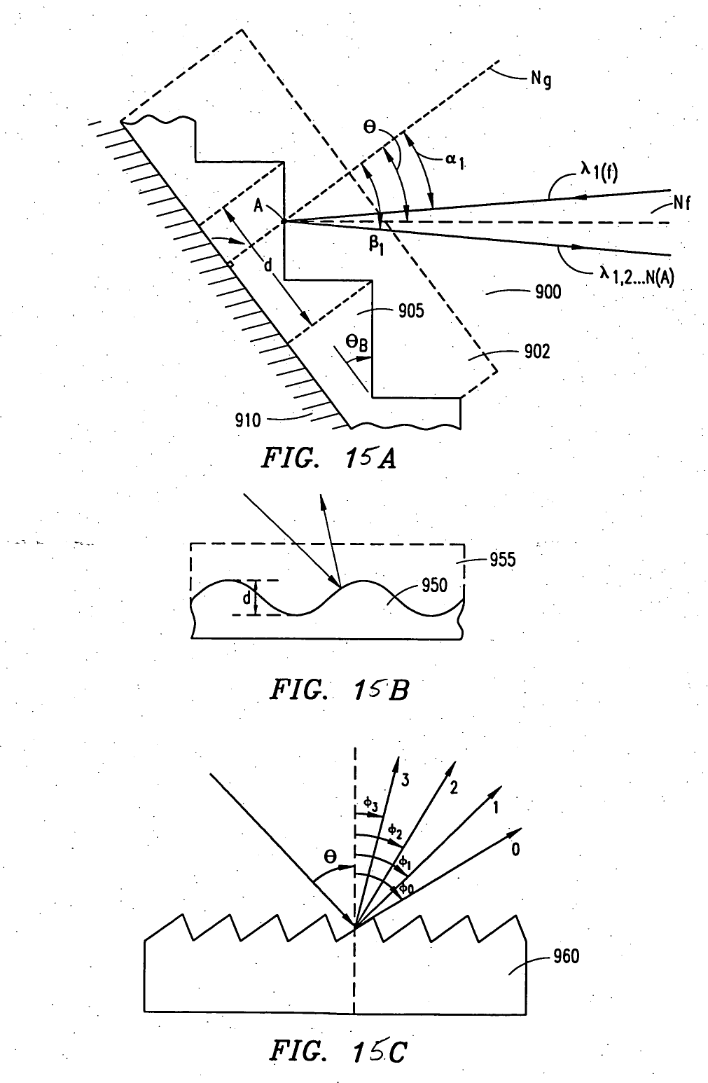

FIG. 14 is a block diagram of a fiber optic network 100 in accordance with an embodiment of the present invention. The fiber optic network 100 provides optical communication between end points 105a, 105b, and 105c. Each end point 105a, 105b, and 105c is coupled to a WDM 110a, 110b, and 110c, respectively, either optically or electrically. In the case of an optical coupling, each end point 105a and 105c communicates a multiple number of narrowband optical signals via fiber optic lines or carriers 112a-112n to the associated WDM 110a-110c, respectively. The end point 105b communicates a multiple number of narrowband optical signals via fiber optic lines or carriers 114a-114d to/from WDM 110b, which multiplexes the narrowband optical signals 114b, 114d to WDM 110d along fiber optic line or carrier 116.

The WDMs 110a and 110c are coupled via a wavelength add/drop device 120 between the fiber optic lines 122a and 122c, respectively. The wavelength add/drop device 120 is, in general terms, a simple form of a wavelength router with two input/output (I/O) ports and an additional third port wherein narrowband optical signals are added to/dropped from the incoming polychromatic optical signal appearing at either I/O port. Within the wavelength add/drop device 120, a pair of WDMs 130a-130b are utilized to separate a received polychromatic optical signal into a plurality of narrowband optical signals and communicate one or more of the narrowband optical signals to end point 105b, via the WDM 110d.

In summary, the present invention overcomes shortcomings in prior diffraction gratings and wavelength division multiplexing/demultiplexing devices and satisfies a significant need for an optical communications device that efficiently multiplexes and/or demultiplexes optical signals.

The present invention is not to be limited in scope by the specific embodiments described herein. Indeed, other various embodiments of and modifications to the present invention, in addition to those described herein, will be apparent to those of ordinary skill in the art from the foregoing description and accompanying drawings. Thus, such other embodiments and modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. A diffraction grating, comprising:
a reflective material having a blazed surface with a blaze angle between about 33 degrees and about 41 degrees; and
an optically transmissive material disposed adjacent the reflective material having an index of refraction (n), wherein the blazed surface of the reflective material has approximately (350±30)*n number of grooves per millimeter.

2. The diffraction grating of claim 1, wherein:
the number of grooves per millimeter for the reflective material is between about 520 and about 560; and
the index of refraction of the optically transmissive material is between about 1.44 and about 1.64.

3. The diffraction grating of claim 1, wherein:
the diffraction order associated with the lowest loss is the second order.

4. The diffraction grating of claim 1, wherein:
the reflective material is at least one of the following: gold material, aluminum material and silver material.

5. The diffraction grating of claim 1, further comprising:
a substantially planar substrate on which the reflective material is formed.

6. A diffraction grating, comprising:
a reflective material having a blazed surface with a blaze angle between about 32 degrees and about 40 degrees; and
an optically transmissive material disposed adjacent the reflective material having an index of refraction (n), wherein the blazed surface of the reflective material has approximately (175±30)*n number of grooves per millimeter.

7. The diffraction grating of claim 6, wherein:
the number of grooves per millimeter for the reflective material is between about 240 and about 300; and
the index of refraction of the optically transmissive material is between about 1.44 and about 1.64.

8. The diffraction grating of claim 6, wherein:
the diffraction order associated with the lowest loss is the fourth order.

9. The diffraction grating of claim 6, wherein:
the reflective material is at least one of the following: gold material, aluminum material and silver material.

10. The diffraction grating of claim 6, further comprising:
a substantially planar substrate on which the reflective material is formed.

11. A wavelength division device, comprising:
a plurality of first coupling components, each first component being capable of receiving a distinct carrier for carrying a signal;
a second coupling component disposed adjacent the first coupling components and capable of receiving a distinct carrier for carrying one or more signals; and
a diffraction grating optically coupled to each carrier received by the first and second coupling components, comprising:
a blazed reflective material having a number of grooves per millimeter and a blazed angle between about 33 degrees and about 41 degrees; and
an optically transmissive material disposed adjacent the reflective material having an index of refraction (n), wherein the number of grooves is approximately equal to (350±30)*n.

12. The wavelength division device of claim 11, wherein:
the number of grooves per millimeter on the diffraction grating is between about 520 and about 560 and the index of refraction is between about 1.44 and 1.64.

13. The wavelength division device of claim 11, wherein:
the diffraction order associated with the lowest loss is the second order.

14. The wavelength division device of claim 11, wherein the diffraction grating has an efficiency of at least 75% over the C-band wavelength range.

15. A wavelength division device, comprising:
a plurality of first coupling components, each first component being capable of receiving a distinct carrier for carrying a signal;
a second coupling component disposed adjacent the first coupling components and capable of receiving a distinct carrier for carrying one or more signals; and
a diffraction grating optically coupled to each carrier received by the first and second coupling components, comprising:
a blazed reflective material having a number of grooves per millimeter and a blazed angle between about 32 degrees and about 40 degrees; and
an optically transmissive material disposed adjacent the reflective material having an index of refraction (n), wherein the number of grooves is approximately equal to (175±30)*n.

16. The wavelength division device of claim 15, wherein:
the number of grooves per millimeter on the diffraction grating is between about 240 and about 300.

17. The wavelength division device of claim 15, wherein:
the diffraction order associated with the lowest loss is the fourth order.

18. The wavelength division device of claim 15, wherein the diffraction grating has an efficiency of at least 70% over the C-band wavelength range.

19. A wavelength division device, comprising:
a means for receiving one or more input optical signals;
a diffraction grating optically coupled to the means for receiving, comprising:
a blazed reflective material having a number of grooves per millimeter and a blazed angle between about 33 degrees and about 41 degrees; and
an optically transmissive material disposed adjacent the reflective material having an index of refraction (n), wherein the number of grooves is approximately equal to (350±30)*n; and
a means for coupling each optical signal diffracted by the diffraction grating onto one or more optical output signals.

20. The wavelength division device of claim 19, wherein the number of grooves per millimeter on the diffraction grating is between about 520 and 560 and the index of refraction is between about 1.44 and about 1.64.

21. A communications apparatus utilizing optical communication, comprising:
a plurality of carriers; and
a wavelength division device, comprising:
a plurality of first coupling components, each first component coupling a distinct carrier for carrying at least one signal within the wavelength division device;
a second coupling component disposed adjacent the first coupling components and coupling a distinct carrier for carrying one or more signals within the wavelength division device; and
a diffraction grating disposed relative to and in optical communication with the carriers coupled to the first and second coupling components so as to diffract one or more input optical rays as a plurality of output optical rays over a wavelength range of at least approximately 30 nm, the diffraction grating comprising:
a blazed reflective material having a number of grooves per millimeter and a blazed angle between about 32 degrees and about 40 degrees; and
an optically transmissive material disposed adjacent the reflective material having an index of refraction (n), wherein the number of grooves is approximately equal to (175±30)*n.

22. The communications apparatus of claim 21, wherein:
the number of grooves per millimeter on the diffraction grating is between about 240 and 300.
